(19) United States
(12) Patent Application Publication
(10) Pub. No.: US 2009/0091336 A1
(43) Pub. Date: Apr. 9, 2009

(54) Capacitive Position Sensor

(76) Inventor: Steven Basil Al-Rawi, Irvine, CA (US)

Correspondence Address: STEVEN AL-RAWI, 26 AMORET DRIVE, IRVINE, CA, 92602, US

(21) Appl. No.: 11/867,571

(22) Filed: Oct. 4, 2007

(51) Int. Cl. G01B 7/30

(52) U.S. Cl. 324/660

(57) ABSTRACT

A method of manufacturing a non-contacting position sensor is disclosed. A sensor manufactured with the disclosed geometry, will typically obtain position resolutions of 1 part in 8*N*2^{M}, when a M bit A/D converter is used to measure induced potentials. The sensor is comprised of a coupling plate and a transceiver plate which may be fabricated using commercially available printed circuit board technologies. Circuitry for energizing the transceiver plate and implementing the position computation algorithm can be easily implemented on the transceiver plate. Thus, a complete sensor can be implemented in the two parts. Said sensor will be insensitive to variations in the gap between elements, small particles and non-conductive surface coatings. The invention can be applied to sense linear or angular motion.

### CROSS REFERENCE

An application (Ser. No. 10,249,316) pertaining to a related device was previously filed. The invention claimed here is more general in scope and includes geometry which facilitates the construction of a sensor yielding more accurate position information.

### BACKGROUND OF INVENTION

The use of position sensors to provide feedback for control systems is well known and ever expanding. The ability to produce these sensors at lower cost, higher life, and improved accuracy has obvious benefits. Potentiometers are often used as position sensors when low cost is a necessity. They are particularly common when the application requires “absolute” position information. However, potentiometers often provide inadequate durability. Performance often degrades as a result of surface contamination and wear. Non-contacting sensing elements essentially eliminate wear issues. However, requirements for high position resolution or absolute position information often drive the cost of non-contacting sensors above the cost of potentiometers. Many non-contacting sensors which provide high position resolution require larger than desired volumes and are degraded by small particles and other surface contaminants. High cost, excessive sensitivity to electromagnetic interference, small range of motion and small allowable gap variation are some of the problems that limit the use of other capacitive position sensors. What is needed, is a non-wearing sensor, with low production cost, high position resolution, immunity to surface contamination and electrical noise and absolute position capability.

### SUMMARY OF INVENTION

The invention is comprised of a coupling element and transceiver element of prescribed geometry, wherein the motion of the coupling element relative to the transceiver element can be computed from electric signals induced on specified transceiver element nodes, as a result of the capacitive coupling between elements. The computation method is also disclosed. To so operate, electrical signals of specified form are applied to specified nodes of the transceiver element. The computation yields a number proportionate to the position change from an initial location. The invention may be used for rotational motion or linear motion. For rotational motion, the tracks are bounded by concentric cylinders. For linear motion, the tracks are bounded by parallel planes. The detailed description defines the required geometry, excitation, and algorithm used to compute relative coupling element position.

### BRIEF DESCRIPTION OF FIGURES

FIG. 1 is a view of a particular embodiment of the invention. In this embodiment, the coupling element and transceiver element are adjacent discs. This embodiment is used for rotational position sensing.

FIG. 2 is a sectional view of the sensor shown in FIG. 1, in which the coupling element conductive areas are clearly visible.

FIG. 3 is a sectional view of the sensor shown in FIG. 1, in which the transceiver element conductive areas are clearly visible;

FIG. 4 is a schematic representing the equivalent circuit elements of the sensor shown in FIG. 1;

FIG. 5 is a graph of the recommended signals, voltage versus time, applied to the transceiver element.

FIG. 6 is a graph of the computed values A and B versus coupling element position.

FIG. 7 defines the terms used in FIG. 8 and FIG. 9.

FIG. 8 is an equation defining how the numerical value A is computed.

FIG. 9 is an equation defining how the numerical value B is computed.

FIG. 10 is a relation which is used to normalize the amplitudes of values A and B.

FIG. 11 is an example of a function used to compute a position for values of A and B.

### DETAILED DESCRIPTION

The invention is comprised of a coupling element and a transceiver element. Each element includes conductive areas of prescribed geometry on a flat surface. The elements are oriented so that said flat surfaces are parallel and adjacent to each other. The spacing between the surfaces is referred to as the sensor gap. In a typical application, the transceiver element is fixed with respect to a body utilizing the position signal, while the coupling disc is fixed to the body for which position information is required.

Said coupling element is made to include a track of 2N identically shaped, equally spaced conductive areas; every other said area being conductively connected to a second conductive track; the remaining N said areas being conductively connected to a third conductive track; the said tracks beings conductively isolated;

Said transceiver element is made to include a track of 4M identically shaped equally spaced conductive areas; every fourth said area being conductively connected; said conductive areas being otherwise conductively isolated; said conductive areas having spacing along said track equal to half the spacing of conductive areas referred to in said coupling element; said transceiver element including a second and third conductive track; all said tracks being conductively isolated from each other; said N and M being positive integers.

For rotational sensors, said tracks are bounded by concentric cylinders. Position changes of the coupling element are restricted to rotations about an axis normal to said adjacent element surfaces and passing through the center of the concentric tracks. The 2N and 4M said conductive areas are annular segments.

For linear sensors, the motion of the coupling element should be restricted to a straight line that is simultaneously parallel to the element tracks and the said adjacent element surfaces. In this case the 2N and 4M segments have rectangular boundaries.

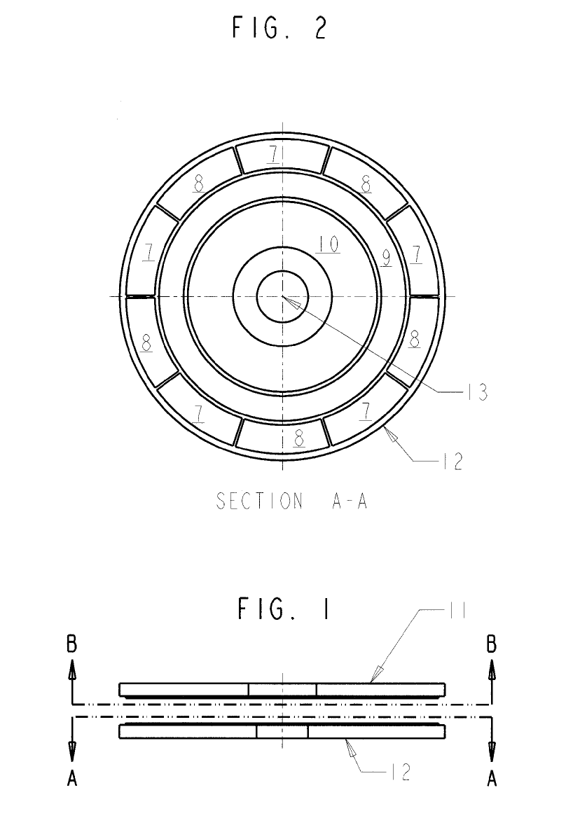

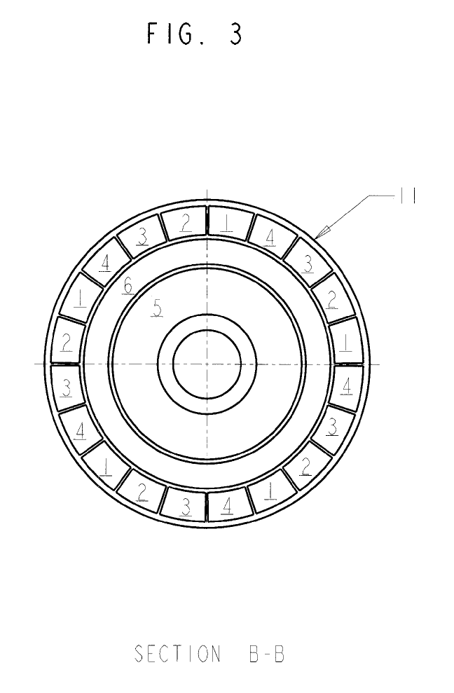

A specific embodiment of the invention is further described, to provide sufficient detail of the invention, so that it may easily be understood. The form of the particular embodiment is illustrated in FIG. 1, FIG. 2, and FIG. 3. In this embodiment, the coupling element 12, and transceiver element 11, are discs. The tracks of each element lie along concentric circles. The first coupling element track is defined by annular segments 7 and 8; the second and third tracks being defined by conductive annuli 9, 10 respectively. The value of N is seen to be 5 which is also the value of M. This embodiment is used to sense angular position.

The first track in the illustrated embodiment of the transceiver disc 11, is defined by annular segments 1, 2, 3, 4. The second transceiver element track is defined by conductive annulus 6. The third transceiver element track is defined by conductive annulus 5.

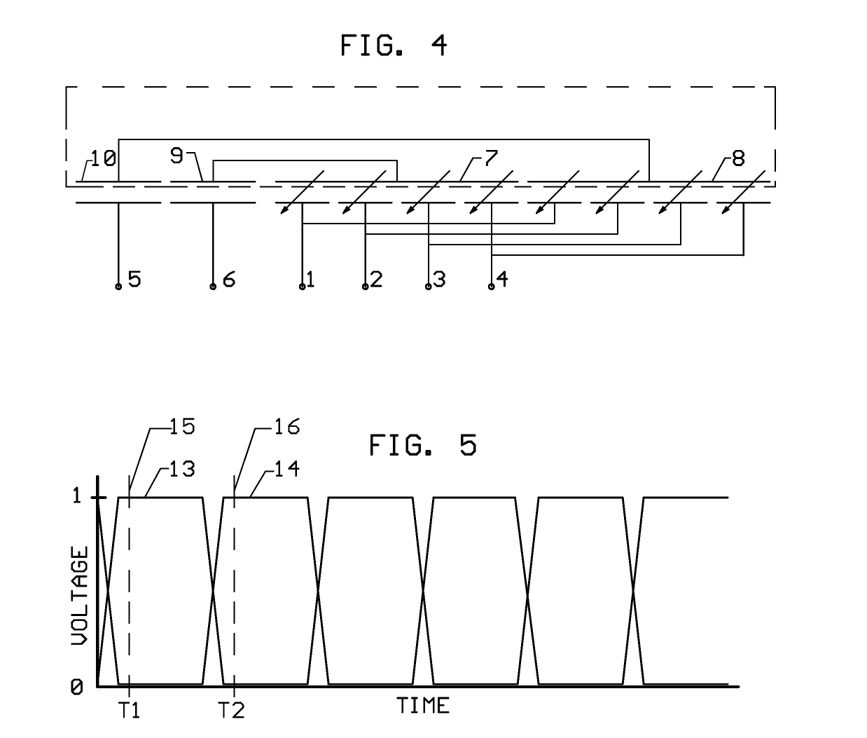

FIG. 4 is a schematic representation of the circuitry which is formed by the elements. The conductive areas perform as capacitive plates in the circuit. By applying the waveforms shown in FIG. 5 to the transceiver element, signals used for position computation are induce on transceiver nodes 1, 2, 3, 4.

In this embodiment signal 13 is applied to transceiver node 5. Simultaneously, signal 14 is applied to transceiver node 6. It should be noted that signal 14 is a half cycle shift of signal 13: The peak to peak amplitude of the signals is typically made equal to the power source potential. In general, the amplitude is chosen to optimize the signals induced on the transceiver nodes 1, 2, 3, 4. A position can be computed for each elapsed cycle of the waveform 13. This is a key consideration in selecting the signal frequency. Other considerations may depend on the sampling time and conversion time required by the circuitry used in the position computation. Rise and fall times are generally limited by circuitry. Normally, they are made small compared to the cycle time.

Conductors 5 and 6 are seen to oppose conductors 10 and 9 respectively, which are made to have nearly identical geometry. For the sensor to provide good accuracy, the capacitive coupling between node 5 and 10 should remain nearly constant over the position range of the coupling disc. Similarly for the capacitance between node 6 and node 9. About third of the available element surface is allocated to the conductive areas defining each of nodes 5 and 6. The conductive connections on the coupling disc assure that the potentials induced on nodes 9 and 10 also appear on conductive areas 7 and 8 respectively.

With the prescribed geometry, the coupling disc may be positioned so that area 8 completely overlaps areas 1 and 2. Simultaneously, area 7 completely overlaps areas 3 and 4. In this position, the capacitive coupling of 8 with 1 and 2 is expected to be maximized. The capacitive coupling of 7 with 3 and 4 should also be maximized.

If the coupling disc of the particular embodiment is now rotated ½N revolutions, area 8 will completely overlap areas 3 and 4 while area 7 overlaps areas 1 and 2. An additional rotation of ½N revolutions of the coupling disc reproduces the coupling of the initial condition considered. It is clear the signal coupling will cycle N times per revolution.

For the position evolution considered in the previous two paragraphs, the coupling of signal 13, having been applied to node 5, to combined areas 1 and 2 will start at a maximum, transition to a minimum and return to a maximum. Simultaneously, the coupling of signal 14 to areas 3 and 4 will start at a maximum, transition to a minimum and return to a maximum.

The induced potentials on nodes 1, 2, 3, 4 are simultaneously measured at time t1 and t2, shown in FIG. 5 as 15 and 16, which occur shortly after the transitions of the excitation waveforms. The delay after transition is dependent on the settling time and acquisition time of the circuitry. The measured amplitudes should nearly repeat with every cycle for a well constructed motionless sensor.

As the coupling disc rotates 1/N revolutions, the coupling of the said nodes vary from a maximum to a minimum to a maximum, and so too must the induced node amplitudes. The numerical value of A is computed from these measured potentials as shown in FIG. 8. The transition of A, 17, from maximum to minimum is shown to be linear in FIG. 6. Linearity is exhibited, to the extent that the coupling change is proportionate to conductive area overlap change. By construction, area overlap change is piecewise linear with respect to position. Minimizing the sensor gap as well as the gaps between the conductive segments, makes these assertions nearly correct and produces more ideal signals.

The computed value of A must be adequate to achieve the desired resolution. The maximum value measured for any node is limited by the maximum conversion value. The minimum measured potential is no less then the minimum conversion value. It follows from FIG. 8, that the value of A has an upper bound of 4 times the conversion span and a lower bound of −4 times the conversion span.

It is recommended, that sensors be constructed to produce nominal transceiver node amplitudes with a range of about 50% of the conversion circuitry span. This allows headroom for variations in element coupling which induces variations in signal amplitude. It should be further noted, that the voltage swing induced in transceiver nodes 1, 2, 3, 4 is dependent on their stray capacitance. A uniform ground plane should be employed in the transceiver element beneath the conductive surfaces 1, 2, 3, 4 to promote a uniform and noise free response in each of the nodes.

Because transceiver areas 2, 3, 4, 1 are positioned identical to a ¼N rotation of transceiver areas 1, 2, 3, 4 respectively, it follows that the signals which are induced on these areas is identical to the signals induced on 1, 2, 3, 4 respectively at a ¼N rotated position. The waveform for computed signal B, 18, is thus as shown in FIG. 6.

The values of A and B shown in FIG. 6 can easily be verified to obey the relation given in FIG. 10 for any position. Furthermore, a unique value of A and B exists for any position in a span of 1/N revolutions. This uniqueness condition and the normalization condition given as FIG. 10, make it possible to compute a unique numerical position from values A and B, for a position span of 1/N revolutions, with the position value being a fixed linear function of the rotation. An example of such a function is given as FIG. 11. In this function, a position from i/N to (i+1)/N rotations is mapped to the interval [0, 4).

When the accuracy of the position value over the of 1/N revolutions span is insufficient, a lookup table can be used to correct the position. In this case, the accuracy can be improved within the limits of resolution and repeatability.

1. A capacitive coupled position sensor, comprising:
A coupling element with a track of 2N identically shaped, equally spaced flat conductive areas; every other said area being conductively connected to a second conductive track; the remaining N said areas being conductively connected to a third conductive track; the said tracks beings conductively isolated;
A transceiver element with a track of 4M identically shaped equally spaced flat conductive areas; every fourth said area being conductively connected; said conductive areas being otherwise conductively isolated; said conductive areas having spacing along said track equal to half the spacing of conductive areas referred to in the coupling element; said transceiver element including a second and third conductive track; all said tracks being conductively isolated from each other; said N and M being positive integers.
Wherein the coupling element is positioned adjacent to the transceiver element so as to obtain a capacitive coupling between the first track of the coupling element and the first track of the transceiver element; between the second track of the coupling element and the second track of the transceiver element; between the third track of the coupling element and the third track of the transceiver element; said capacitive couples between tracks remaining nearly constant over the range of coupling element positions for which position is sensed.

2. The sensor according to claim 1, wherein the conductive track areas of the elements are bounded by concentric cylinders.

3. The sensor according to claim 2, wherein N equals M.

4. The sensor according to claim 3, which is used in the controlled commutation of brushless motors.

5. The sensor according to claim 1, wherein the conductive track areas of the elements are bounded by parallel planes.

6. The sensor according to claim 3, wherein the waveforms of FIG. 8 are applied to the transceiver element.

7. The sensor according to claim 5, wherein the waveforms of FIG. 8 are applied to the transceiver element.

8. The sensor according to claim 1, where the elements are comprised of printed circuit boards.

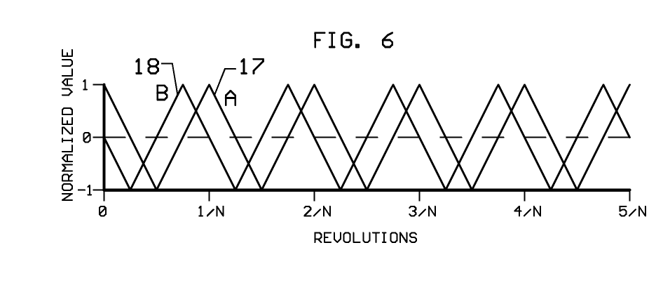

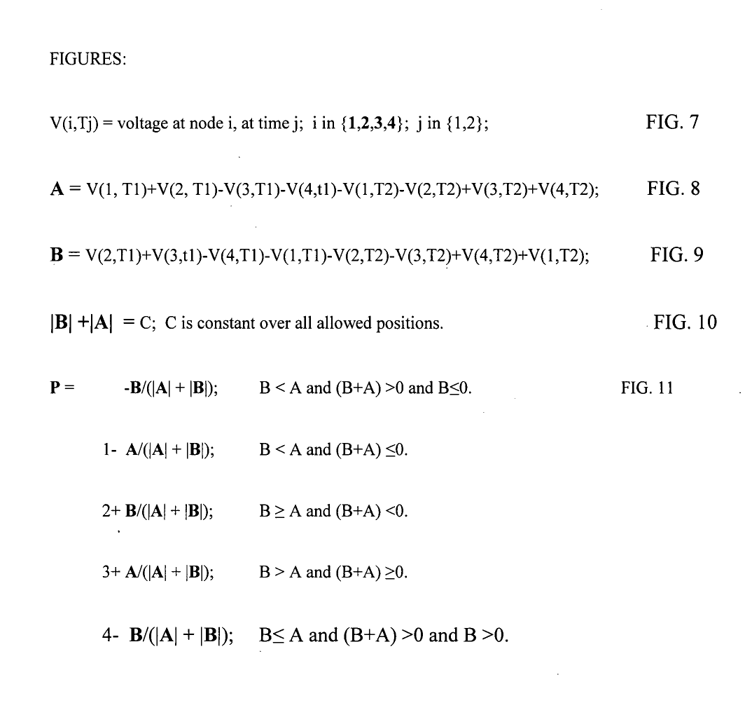

9. The sensor according to claim 1, wherein an absolute position is computed using the normalization condition given by the equation in FIG. 7.

10. A sensor containing multiple copies of the sensor according to claim 1, Where-in the multiple copies are used to compute an absolute position for a range of motion larger than obtainable with any single copy.
